(19) United States
(12) Patent Application Publication
(10) Pub. No.: US 2006/0281649 A1
(43) Pub. Date: Dec. 14, 2006

(54) Cleaning material manufacturing method, cleaning material manufacturing apparatus and cleaning system

(75) Inventors: Takeshi Tanaka, Tokyo (JP); Takeshi Yamamoto, Tokyo (JP); Masuo Tada, Tokyo (JP)

Correspondence Address: KODA & ANDROLIA, 2029 CENTURY PARK EAST, SUITE 1140, LOS ANGELES, CA, 90067, US

(73) Assignee: Taiyo Nippon Sanso Corporation

(21) Appl. No.: 11/154,164

(22) Filed: Jun. 16, 2005

(30) Foreign Application Priority Data
Jun. 17, 2004 (JP) 2004-179219

(51) Int. Cl. C11D 3/02

(52) U.S. Cl. 510/108

(57) ABSTRACT

A method for manufacturing a cleaning material wherein a supercooled liquid formed by cooling a raw material liquid, which is comprised of water or a mixed liquid composed of water and a liquid organic compound having a freezing point lower than that of water, to a supercooled state is jetted into a cleaning material manufacturing vessel, thus forming a turbulent flow region of the supercooled liquid inside the manufacturing vessel, and a portion of the supercooled liquid jetted contacts seed ice generated inside the manufacturing vessel, so that the supercooled liquid undergoes a phase change into ice particles, and these ice particles are grown by being subjected to turbulent flow agitation in the turbulent flow region, thus producing a cleaning material with a sherbet-like consistency showing co-presence of a solid and liquid in which ice particles and a liquid are mixed.

### BACKGROUND OF THE INVENTION

1. Technical Field

The present invention relates to a method and apparatus for manufacturing a cleaning material that can be suitably used in cases where fine contaminant substances (such contaminant substances comprising fine particles and the like that are the source of contamination of substrates and are hereafter referred to as “particles”) adhering to various types of substrates (e.g., semiconductor wafers, substrates of electronic devices, liquid crystal substrates, photo-masks, glass substrates and the like) are cleaned and removed, and further to a cleaning system that uses this cleaning material manufacturing apparatus.

2. Description of the Related Art

The cleaning of, for instance, substrates such as semiconductor wafers and the like is generally performed by means of a brush scrubber which removes particles adhering to such substrates by scrubbing the substrate surface with a brush using mohair, nylon or the like with a bristle diameter of 100 to 300 μm. However, in the case of substrate cleaning by means of such a brush scrubber, a technique is used in which the brush is pressed against the substrate surface while being rotated, so that foreign matter is removed by the resulting frictional force; accordingly, fine particles that constitute a source of substrate contamination are generated by rubbing between brush bristles and rubbing into steps in the substrate wiring, and these particles re-adhere to the substrate, thus lowering the substrate cleaning effect.

Recently, therefore, ice scrubbers have been proposed. In ice scrubbers, fine ice particles are sprayed onto the substrate as a cleaning material by means of a carrier gas, and are caused to collide with the substrate (e.g., see Japanese Patent Application Laid-Open (Kokai) No. H8-274056). In the case of such ice scrubbers, the substrates are rinsed off; accordingly, the generation and re-adhesion of particles can be prevented by appropriately devising the structure of the cleaning tank, so that substrate cleaning can be effectively performed.

However, in the case of substrate cleaning by means of ice scrubbers, the cleaning material consists of extremely hard ice particles using liquid nitrogen, and these particles are caused to strike the substrate at a high velocity by means of gas (carrier gas); accordingly, there is a danger that the substrate will be damaged by such collision of the cleaning material. Furthermore, the kicking up of the contaminant particles that are removed as the ice particles are scattered following collision with the substrate cannot be avoided, so that there is a danger of re-contamination of the substrate. In order to prevent such a kicking up of the contaminant particles, it is necessary to rinse the substrate with pure water or the like together with the spraying of the ice particles so that the contaminant particles are not kicked up. However, if such rinsing is performed, the ice particles melt in the rinse water, so that the heat of cooling cannot be effectively utilized, and this leads to the problem of increased running costs. Furthermore, the ice particles fuse together to form lumps, resulting in the problem of conspicuously poor handling characteristics, such as clogging of the transport piping and the like.

### BRIEF SUMMARY OF THE INVENTION

The object of the present invention is to provide a method and apparatus for manufacturing a cleaning material which can favorably and effectively clean substrates or the like without causing the problems encountered in the above-described ice scrubbers in cases where a cleaning material is thus sprayed onto and caused to collide with members that are the object of cleaning such as these substrates or the like; and further the present invention provides cleaning system that this cleaning material manufacturing apparatus.

The above object is accomplished by unique steps of the present invention for a cleaning material manufacturing method, and the manufacturing method of present invention comprises the unique steps of:
obtaining a supercooled liquid which is formed by cooling a raw material liquid which is for the cleaning material and is either water or a mixed liquid that comprises water and a liquid organic compound which has a lower freezing point than water;
creating a turbulent flow region of the supercooled liquid inside a cleaning material manufacturing vessel by causing this supercooled liquid to jet into the vessel from a supercooled liquid squirt opening formed in one end portion of the vessel;
obtaining a cleaning material which has a sherbet-like consistency showing the co-presence of a solid and liquid in which ice particles and a liquid are mixed, such being accomplished by causing a portion of the supercooled liquid that is caused to jet from the supercooled liquid squirt opening to contact seed ice that is generated inside the vessel, so that a phase change into ice particles is effected, and by performing turbulent flow agitation in the turbulent flow region so as to grow the ice particles; and
finally causing the cleaning material thus obtained to flow out of the vessel into a cleaning material supply path that is connected to the other end portion of this vessel.

Generally, when the temperature of water drops, the kinetic energy of the water molecules decreases. On the other hand, energy (activation energy) is required in order to generate ice nuclei (ice crystals). Accordingly, even in cases where the temperature of water drops below the freezing point (ice point), a state in which ice crystals are not formed results if the kinetic energy of the water molecules is reduced so that sufficient energy cannot be obtained. Such a state is referred to as a supercooled state and is an extremely unstable state in thermodynamic terms. If a fixed amount of energy or more (shock, vibration, heat) is applied, such a supercooled state disappears, and ice crystals are formed.

In the cleaning material manufacturing method of the present invention, supercooling is dissolved by applying thermal energy to the supercooled liquid by means of contact between the seed ice (0° C.) and supercooled liquid (−0.5° C. to −50° C.) in addition to the physical energy of spraying the supercooled liquid from a nozzle body, so that a portion of the supercooled liquid is caused to undergo a phase change into ice crystals.

Next, the ice crystals resulting from this phase change are mixed and agitated with the supercooled liquid that flows continuously into the cleaning material manufacturing vessel, so that these ice crystals grow and aggregate into ice particles (in the observations conducted by the inventors of the present application, the ice crystals aggregated into needle-form ice particles). However, a turbulent flow region is formed inside the cleaning material manufacturing vessel as a result of the spraying of the supercooled liquid from the nozzle body, and the resulting shearing force prevents excessive aggregation of the ice particles from occurring, so that a sherbet-like cleaning material in which a solid (ice particles) and a liquid (water or a mixed aqueous solution of water and a liquid organic compound such as isopropyl alcohol or the like) are co-present is obtained. In cases where the turbulent flow action, i.e., shearing force, of the turbulent flow region is weak, the ice particle undergo excessive aggregation and increase in size so that problems such as clogging of the piping or the like may occur.

As seen form the above, as a result of the supercooled liquid contacting the seed ice, a portion of the supercooled liquid undergoes a phase change into ice crystals. Once such ice crystals have been formed, if ice particles are present in a state in which these ice particles circulate through the cleaning material manufacturing vessel, then a phase change of the supercooled liquid will occur continuously even if no seed ice is present; accordingly, the seed ice generating mechanism may be stopped. Furthermore, the grown ice particles tend to adhere to the wall surfaces of the cleaning material manufacturing vessel; however, these ice particles are continuously stripped from the vessel wall surfaces by the turbulent flow action of the supercooled liquid. The cleaning material thus obtained is caused to flow out continuously from the cleaning material manufacturing vessel into the cleaning material supply passage that is connected to the other end portion of this vessel.

In the cleaning material manufacturing method of the present invention, in cases where the cleaning material is used in an application that requires a high degree of anti-contamination countermeasures, e.g., cases in which substrates such as silicon wafers or the like are cleaned, it is preferable to use pure water, a mixed liquid composed of pure water and a liquid organic compound having a freezing point lower than that of pure water, pure water with carbon dioxide added thereto, or a mixed liquid with carbon dioxide added thereto wherein the mixed liquid is composed of pure water and a liquid organic compound having a freezing point lower than that of water, as the raw material liquid.

In cases where a mixed liquid with a liquid organic compound is used as the raw material liquid, it is preferable that a liquid organic compound that has no deleterious effect on the member that is the object of cleaning such as a substrate or the like (i.e., the surface that is the object of cleaning) be used as the liquid organic compound. In concrete terms, for example, it is preferable to use isopropyl alcohol (mp=−89.5° C., bp=82.4° C.), methyl alcohol (mp=−97.78° C., bp=64.65° C.), ethyl alcohol (mp=−114.1° C., bp=78.3° C.), acetone (mp=−94.82° C., bp=56.5° C.), a mixture of two or more of these organic compounds or the like, and in particular, the use of isopropyl alcohol (hereafter abbreviated to “IPA”) is especially desirable.

In cases where a mixed liquid composed of water and a liquid organic compound is used as the raw material liquid, it is preferable to set the concentration of the liquid organic compound in the raw material liquid or cleaning material at 0.01 mass % to 70 mass %. More specifically, if the concentration of the liquid organic compound is less than 0.01 mass %, the significance of adding such a liquid organic compound is lost, while if this concentration exceeds 70 mass %, the temperature at which the water content in the raw material liquid freezes drops greatly, so that a needlessly large amount of energy (energy required for freezing) is required in order to manufacture the cleaning material.

Furthermore, it is also desirable to inject carbon dioxide gas into the raw material liquid, thus lowering the resistivity of the cleaning material, and preventing static electricity caused by the cleaning material during cleaning.

In addition, besides using water such as pure water or the like, it is also possible to use a liquid with the same components as the raw material liquid (i.e., a mixed liquid that comprises water and a liquid organic compound) as the seed ice raw material liquid that is the raw material of the seed ice. In this case, it is preferable that the concentration of the liquid organic compound in the seed ice raw material liquid be set at a concentration that is the same as or lower than the concentration of the liquid organic compound in the raw material liquid.

The degree of turbulent flow that is generated by the jetting of the supercooled liquid from the supercooled liquid squirt opening must be sufficient to strip the grown seed crystals that are fixed to the inside wall surfaces of the vessel and to prevent adhesion of the ice particles that are generated in the supercooled liquid to the vessel. Accordingly, it is necessary to design the vessel shape, size of the supercooled liquid squirt opening and the like so that such conditions are satisfied. It is thus desirable to devise the vessel so that the jet velocity from the supercooled liquid squirt opening is, for instance, 1 m/sec to 20 m/sec.

There is a danger that ice particles will adhere and grow around the periphery of the supercooled liquid squirt opening, thus clogging this squirt opening. In order to prevent such a danger, besides setting the jet velocity as described above, it is preferable to take the measures as follows: in regard to the cylindrical shape of the cleaning material manufacturing vessel, it is preferable that one end portion be closed off by an end portion wall, and that a nozzle body whose tip end opening is used as a supercooled liquid squirt opening be disposed in this end portion wall in a state in which this nozzle body is caused to protrude into the vessel from the end portion, so that a reverse flow is formed which is oriented toward the squirt opening from the end portion wall along the outer circumferential surface of the nozzle body. Furthermore, it is preferable that at least the contact surface of the nozzle body and end portion wall with the supercooled liquid be formed with a low-temperature-resistant material that is superior in terms of hydrophobic properties and low thermal conductivity (PTFE (polytetrafluoroethylene), PFA (per fluoro alkoxy fluoroplastics) or the like).

The above object is further accomplished by a unique structure of the present invention for a cleaning material manufacturing apparatus for working the cleaning material manufacturing method; this manufacturing apparatus of the present invention comprises:
a cylindrical cleaning material manufacturing vessel;
a supercooled liquid introduction passage which is connected to one end portion of this vessel and has a squirt opening formed in the tip end;
a cleaning material supply passage which is connected to another end portion of the cleaning material manufacturing vessel;
a supercooled liquid manufacturing mechanism which cools a raw material liquid, which is for the cleaning material and is water, a mixed liquid composed of water and a liquid organic compound having a freezing point lower than that of water, water with carbon dioxide added thereto, or a mixed liquid with carbon dioxide added thereto wherein the mixed liquid is composed of water and a liquid organic compound having a freezing point lower than that of water, into a supercooled state, and causes thus obtained supercooled liquid to jet into the vessel from the squirt opening; and
a seed ice generating mechanism which generates seed ice in a turbulent flow region formed inside the vessel by the supercooled liquid that is caused to jet from the squirt opening; and

in this structure, a portion of the supercooled liquid is caused to undergo a phase change into ice particles by contact with the seed ice, and these ice particles are caused to grow, in the turbulent flow region, thus producing a cleaning material which has a sherbet-like consistency showing the co-presence of a solid and liquid in which ice particles and a liquid are mixed, and causing the cleaning material thus obtained to flow out of the vessel into the cleaning material supply passage.

In this cleaning material manufacturing apparatus, it is preferable that the cleaning material manufacturing vessel be formed with a cylindrical shape, that one end portion of this vessel be closed off by an end portion wall, that a nozzle body whose tip end opening part is used as the supercooled liquid squirt opening be formed in this end portion wall in a state in which this nozzle body is caused to protrude into the cleaning material manufacturing vessel from this end portion, and that the manufacturing apparatus be constructed so that a turbulent flow region is inside the cleaning material manufacturing vessel and a reverse flow is formed which is oriented toward the squirt opening from the end portion wall along the outer circumferential surface of the nozzle body.

It is preferable that the internal diameter dimension of the cleaning material manufacturing vessel be approximately 5 to 50 mm, and the opening diameter of the nozzle body used as the supercooled liquid squirt opening varies according to the combination with the shape of the cleaning material manufacturing vessel that is used as well, but it is preferable that this opening maintain the flow velocity of the jetting supercooled liquid at approximately 1 to 20 m/sec. In this case, it is preferable that at least the contact surface of the nozzle body and end portion wall with the supercooled liquid be formed with a low-temperature-resistant material such as PTFE, PFA or the like that is superior in terms of hydrophobic properties and low thermal conductivity.

Furthermore, it is preferable that the central axes of the cleaning material manufacturing vessel and nozzle body be caused to coincide.

It is further desirable that the cleaning material manufacturing vessel be constructed as a vessel with a cylindrical shape whose central axis extends in the vertical direction or horizontal direction, that a supercooled liquid introduction passage be connected to one end portion of the vessel, and that a cleaning material supply passage be connected to the other end portion of this vessel.

In addition, it is preferable that the seed ice generating mechanism be constructed as a mechanism which comprises a seed ice generating opening formed in the circumferential wall of the cleaning material manufacturing vessel, a seed ice generating passage which is connected to this seed ice generating opening, and a cooler which generates seed ice by cooling the seed ice raw material liquid that is resident in this seed ice generating passage.

The distance from the nozzle body constituting the supercooled liquid squirt opening to the seed ice generating opening varies according to the combination with the shape of the cleaning material manufacturing vessel that is used; generally, however, it is preferable that this distance be set at 20 to 300 mm.

The above-described object is further accomplished by a unique structure of the present invention for a cleaning system that includes the cleaning material manufacturing apparatus constructed as described above and a cleaning apparatus. In this cleaning system, the cleaning apparatus comprises a cleaning treatment chamber which holds a member that is the object of cleaning, and a cleaning material spray mechanism which spays a cleaning material that is supplied from the cleaning material supply passage onto the member that is the object of cleaning held inside the cleaning treatment chamber.

In the cleaning material supply passage that leads to the cleaning material spray mechanism from the cleaning material manufacturing apparatus, it is preferable that the cleaning material that flows through this passage is maintained at a temperature of −0.5° C. to −50° C. Furthermore, it is preferable that the cleaning system be equipped with a spray gun that uses a carrier gas to accelerate and spray the cleaning material that is supplied from the cleaning material supply passage.

The cleaning material manufacturing method and cleaning material manufacturing apparatus of the present invention described above allows the efficient and favorable manufacture of a sherbet-form cleaning material that can favorably and effectively clean surfaces that are the object of cleaning such as substrates or the like without creating problems of the kind encountered in cases where the brush scrubbers or ice scrubbers described above are used (e.g., secondary contamination of the substrate, damage to the element and the like).

Furthermore, with the cleaning material manufacturing method of the present invention, it is possible to reduce the running cost required in the cleaning of such substrates or the like, and it is further possible to easily perform continuous operation without causing problems such as clogging of the piping system or the like.

### BRIEF DESCRIPTION OF THE SEVERAL VIEWS OF THE DRAWINGS

FIG. 1 is a system diagram showing one example of the cleaning system of the present invention;

FIG. 2 shows the essential portions of the cleaning system of the present invention shown in FIG. 1, being a longitudinally sectional front view showing one example of the cleaning material manufacturing apparatus of the present invention;

FIG. 3 is a system diagram corresponding to FIG. 1, illustrating a modification of the cleaning system of the present invention shown FIGS. 1 and 2;

FIG. 4 is a system diagram corresponding to FIG. 1, illustrating another modification of the cleaning system of the present invention shown in FIGS. 1 and 2;

FIG. 5 is an enlarged diagram of the cleaning material obtained by the cleaning system of the present invention; and

FIG. 6 is a graph showing the correlations of a substrate damage generation rate and a particle removal rate to cleaning material spray velocity seen when substrate cleaning is performed using the cleaning system of the present invention.

### DETAILED DESCRIPTION OF THE INVENTION

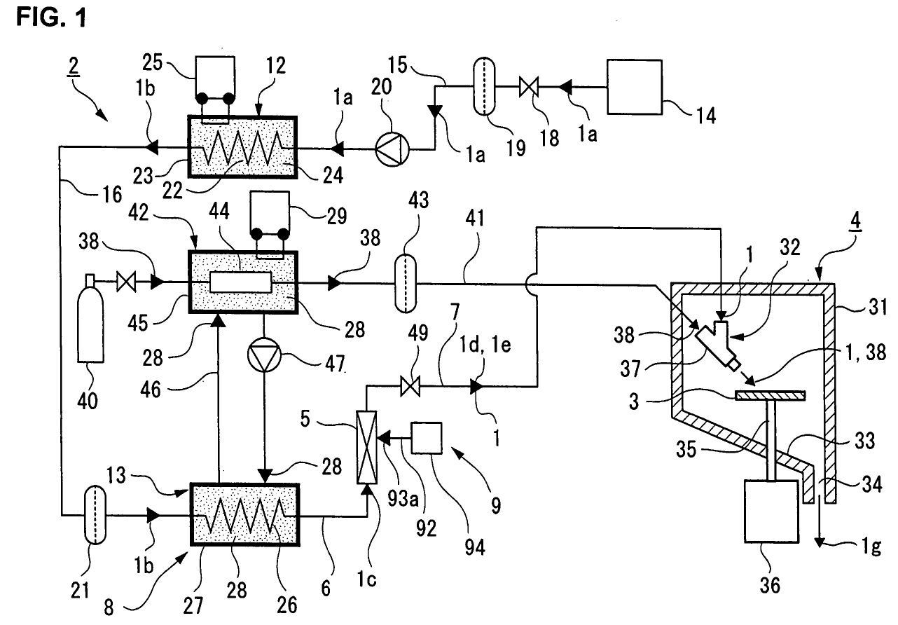

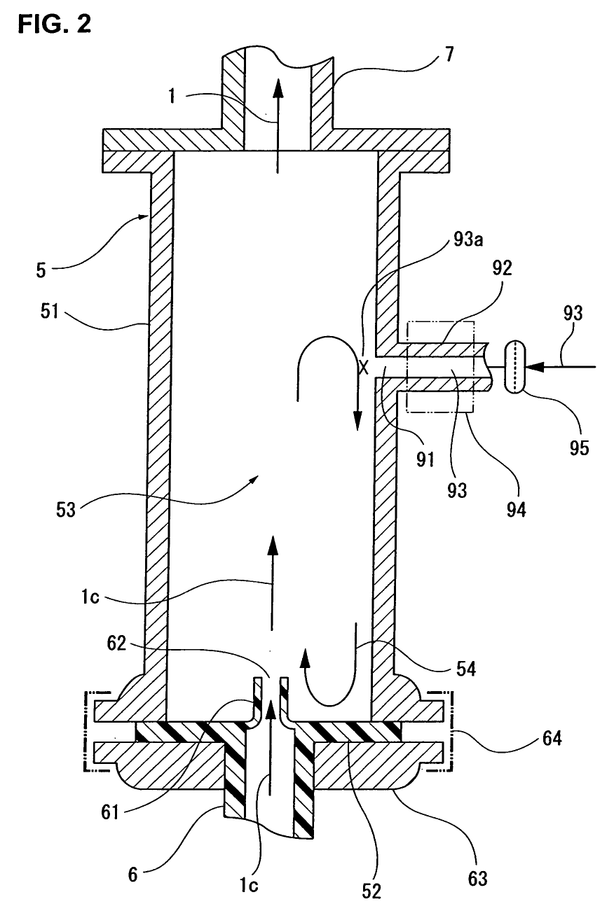

FIG. 1 is a system diagram which shows one example of the cleaning system of the present invention, and FIG. 2 is an enlarged detailed diagram of the essential portion of this system.

The cleaning system shown in FIG. 1 is used to clean substrates (semiconductor wafers, substrates of electronic devices, liquid crystal substrates, photo-masks, glass substrates or the like), i.e., to remove contaminant particles from the substrates, by spraying a cleaning material onto these substrates and causing this cleaning material to collide with the substrates in the same manner as in an ice scrubber. The cleaning system comprises a cleaning material manufacturing apparatus 2 that manufactures a sherbet-like cleaning material 1 and a cleaning apparatus 4 that cleans the substrate 3 (constituting the object of cleaning) by spraying the cleaning material 1 onto the substrate 3.

As shown in FIG. 1, the cleaning material manufacturing apparatus 2 of the present invention comprises a cleaning material manufacturing vessel 5, a supercooled liquid introduction passage 6, a cleaning material supply passage 7, a supercooled liquid manufacturing mechanism 8 and a seed ice generating mechanism 9.

As shown in FIG. 2, the cleaning material manufacturing vessel 5 is a cylindrical vessel whose central axis extends in the vertical direction; this vessel consists of a cylindrical circumferential wall 51 made of metal, and an end portion wall 52 that closes off the bottom end portion of this vessel.

As seen from FIG. 2, the supercooled liquid introduction passage 6 is a round pipe which has a nozzle body 61 on the tip end and is connected to the lower end portion of the cleaning material manufacturing vessel 5. This pipe is constructed from a low-temperature-resistant material (PTFE, PFA or the like) which is superior in terms of hydrophobic properties and low thermal conductivity. The nozzle body 61 is a cylindrical body with a fixed internal diameter, and it has a supercooled liquid squirt opening 62 comprising a small-diameter orifice formed on the tip end. The shape of the nozzle body 61 and the diameter of the supercooled liquid squirt opening 62 are appropriately set with the formation of a turbulent flow region 53 and the formation of a reverse flow 54 (described later) by the jet flow from the squirt opening 62 as conditions.

As shown in FIG. 2, the cleaning material supply passage 7 is a round pipe with a diameter that is smaller than that of the cleaning material manufacturing vessel 5, and it is concentrically connected to the upper end portion of this vessel 5. Furthermore, the cleaning material supply passage 7 is not limited to the shown embodiment; this passage can be a cylindrical tube with a diameter that is equal to or greater than that of the cleaning material manufacturing apparatus 5.

As shown in FIG. 1, the supercooled liquid manufacturing mechanism 8 comprises a pre-cooler 12, a supercooler 13, a raw material liquid supply passage 15 which extends from the supply source 14 of the raw material liquid 1a for the cleaning material to the pre-cooler 12, a pre-cooled liquid supply passage 16 which extends from the pre-cooler 12 to the supercooler 13, a supercooled liquid introduction passage 6 which extends from the supercooler 13 to the cleaning material manufacturing vessel 5, a raw material liquid supply valve 18, filter 19 and pressurizing pump 20 which are disposed in the raw material liquid supply passage 15, and a filter 21 which is disposed in the pre-cooled liquid supply passage 16.

Water or a mixed liquid that comprises water and a liquid organic compound which has a lower freezing point than water is used as the raw material liquid for the cleaning material. It is preferable that pure water be used as this water, and that IPA or the like be used as this liquid organic compound.

As shown in FIG. 1, the pre-cooler 12 is a heat exchanger that is comprised of a heat transfer pipe 22 whose inlet and outlet parts are connected to the raw material liquid supply passage 15 and pre-cooled liquid supply passage 16, a heat exchanger main body 23 which contains this heat exchange pipe 22, a cooling medium (e.g., a cooling medium liquid such as ethylene glycol or the like) 24 which fills the interior of this heat exchanger main body 23, and a freezer 25 which cools this cooling medium 24.

The thus structured pre-cooler 12 pre-cools the raw material liquid 1a for the cleaning material at an ordinary temperature (that is pressurized to a specified pressure by the pressurizing pump 20 and supplied to the heat transfer pipe 22 from the raw material liquid supply passage 15) to an appropriate temperature (e.g., a temperature within approximately 2° C. of the ice point) by means of heat exchange with the cooling medium 24, and the pre-cooled liquid 1b comprising the pre-cooled raw material liquid 1a is supplied to the supercooler 13 from the pre-cooled liquid supply passage 16.

The pre-cooler 12 lightens the burden on the supercooler 13 described later. The pre-cooler 12 is installed in order to keep the outlet temperature of the supercooler 13 at a constant temperature. In cases where this supercooler 13 has a cooling capacity that is sufficient to supercool the raw material liquid 1a at ordinary temperatures, this pre-cooler 12 is not necessary.

The supercooler 13 is a heat exchanger that is comprised of a heat transfer pipe 26 whose inlet and outlet are connected to the pre-cooled liquid supply passage 16 and supercooled liquid introduction passage 6, a heat exchanger main body 27 which contains this heat transfer pipe 26, a cooling medium (e.g., a cooling medium liquid such as ethylene glycol or the like) 28 which fills the interior of this heat exchanger main body 27, and a freezer 29 which cools this cooling medium 28.

The supercooler 13 supercools the pre-cooled liquid 1b (supplied from the pre-cooled liquid supply passage 16 to the heat transfer pipe 26 at a specified pressure by means of the pressurizing pump 20) to a temperature of −0.5 to −50° C. by means of heat exchange with the cooling medium 28, thus producing a supercooled liquid 1c comprising the raw material liquid maintained in a supercooled state.

In the shown embodiment, as will be described later, the cooling medium 28 of the supercooler 13 is circulated between the supercooler 13 and the cooler 42 by means of a cooling medium circulating passage 46 and a cooling medium circulating pump 47 that is disposed in this passage, so that the cooling medium 28 is cooled by the freezer 29 on the side of the cooler 42. The supercooled liquid 1c obtained by the supercooler 13 is pressurized to a specified pressure by the pressurizing pump 20 and is supplied to the supercooled liquid introduction passage 6; this supercooled liquid 1c is then caused to jet upward inside the cleaning material manufacturing vessel 5 from the supercooled liquid squirt opening 62.

The pressurizing pump 20 is operated so that the jetting velocity of the supercooled-liquid 1c from the supercooled liquid squirt opening 62 is 1 m/sec to 20 m/sec as described above.

The supercooled liquid manufacturing mechanism 8 maintains the supercooled liquid temperature in the path leading to the supercooled liquid squirt opening 62 at a temperature which is such that the supercooled liquid 1c is caused to flow in a stable supercooled state to the supercooled liquid squirt opening 62.

As seen from FIG. 2, the seed ice generating mechanism comprises a seed ice generating opening 91 which is formed in the vessel circumferential wall 51 so as to face the upper side portion of the turbulent flow region 53 formed by the jet flow of the supercooled liquid 1c from the supercooled liquid squirt opening 62, a seed ice generating passage 92 which is connected to the seed ice generating opening 91, a cooler 94 which generates seed ice 93a by cooling the seed ice raw material liquid (seed ice raw material) 93 residing in the seed ice generating passage 92, and a filter 95.

The cooler 94 may be any cooler that is capable of producing seed ice 93a by cooling the seed ice raw material liquid 93. The seed ice 93a injected into the turbulent flow region 53 is continuously stripped away by contact with the supercooled liquid 1c in the turbulent flow region 53 and is mixed and agitated with the supercooled liquid 1c. The vertical distance from the supercooled liquid squirt opening 62 to the seed ice generating opening 91 is appropriately set in accordance with the internal diameter of the vessel and the like (ordinarily, it is preferable that this distance be set at 20 to 300 mm).

In the cleaning material manufacturing apparatus 2 constructed as described above, the seed ice 93a is fixed to the inside surfaces of the circumferential wall 51 of the vessel and grows as a result of contact with the supercooled liquid 1c. Furthermore, the grown seed ice 93a is continuously stripped away from the vessel 5 by the turbulent flow action of the supercooled liquid 1c. As a result, in the turbulent flow region 53, the stripped seed ice 93a and the supercooled liquid 1c are mixed and agitated, so that a portion of the supercooled liquid 1c is caused to undergo a phase change into ice particles, thus producing a cleaning material 1 with a sherbet-like consistency showing the co-presence of a liquid and solid in which ice particles 1d and a liquid 1e are mixed.

Subsequently, when the effect of dissolving the supercooled liquid 1c no longer requires seed ice 93a, the generation of seed ice 93a is stopped, and a cleaning material 1 continues to be produced in the turbulent flow region 53. Here, the supercooling of the supercooled liquid 1c can be efficiently dissolved by turbulent flow agitation, and the cleaning material 1 thus produced continuously flows out into the cleaning material supply passage 7 from the cleaning material manufacturing vessel 5. In the cleaning material 1 thus produced, since the growth of ice due to the mutual coupling of ice particles can be prevented by the agitating effect of turbulent flow, no large ice particles are contained in the liquid feeding passage on the downstream side of the cleaning material manufacturing vessel, and this cleaning material 1 has a good sherbet-like consistency showing the co-presence of a solid and liquid.

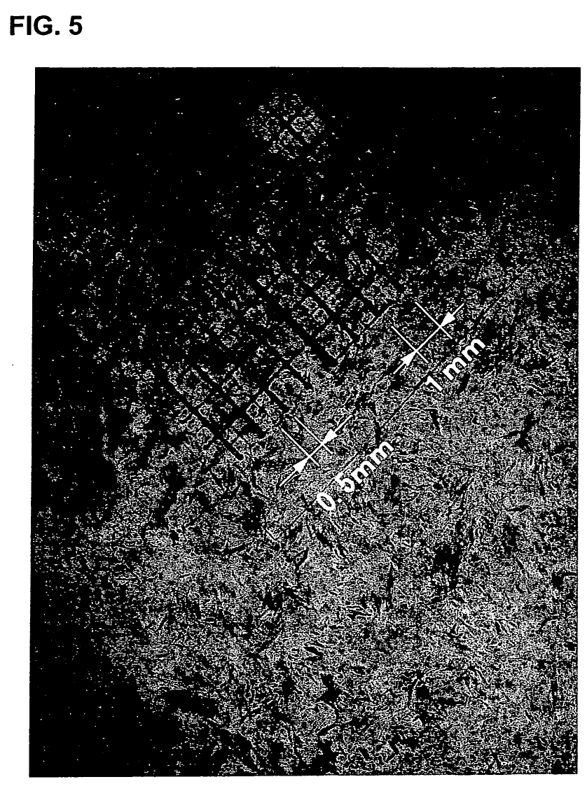

FIG. 5 shows the cleaning material 1 obtained as described above. It was confirmed by the inventors of the present application that the ice particles are aggregated in needle form (length: 80 to 500 μm, average: 300 μm) in the sherbet-like cleaning material 1 obtained by means of the present invention.

Furthermore, since the nozzle body 61 protrudes from the end portion wall 52 in the lower part of the vessel 5, a reverse flow 54 that is oriented upward along the outer circumferential surfaces of the nozzle body 61 from the end portion wall 52 is formed by the jet flow from the supercooled liquid squirt opening 62. Accordingly, the accumulation and adhesion of ice particles in the supercooled liquid squirt opening 62 and area surrounding this opening can be effectively prevented by this reverse flow 54; and even if adhesion does occur, the ice particles can easily be stripped away, so that blocking of the supercooled liquid squirt opening 62 or the like can be prevented. Such an anti-blocking effect can be manifested even more conspicuously by constructing the nozzle body 61 and end portion wall 52 from a plastic material such as PTFE or the like that is superior in terms of hydrophobic properties and low thermal conductivity, thus reducing the adhesive force of the ice particles 1d at the liquid contact surfaces with the supercooled liquid 1c.

In the flow path extending from the supply source 14 of the raw material liquid 1a to the area of cleaning use (the flow path through which the raw material liquid 1a, pre-cooled liquid 1b, supercooled liquid 1c and cleaning material 1 flow), filters 19 and 21 that are used to remove contaminant particles are installed. However, in order to prevent the generation of contaminant particles even more effectively, it is preferable to manufacture the respective flow passages 7, 15, 16, 22 and 26 and the cleaning material manufacturing vessel 5 from a plastic such as PTFE or the like that does not generate contaminant particles, or to subject the inside surfaces of these elements that constitute fluid contact surfaces to an electrolytic polishing treatment or a plastic coating treatment with PTFE or the like.

Furthermore, it is preferable that the flow path of the supercooled liquid 1c (supercooled liquid introduction passage 6 and the like) have a configuration in which no part that applies a shock that will dissolve the supercooled state (e.g., elbow part with a small curvature radius, part in which the cross-sectional area varies abruptly or the like) is created.

As shown in FIG. 1, the cleaning apparatus 4 comprises a cleaning treatment chamber 31 and a cleaning material spray mechanism 32. The cleaning material spray mechanism 32 sprays the cleaning material 1 manufactured by the cleaning material manufacturing apparatus 2 toward the surface that is to be cleaned (front surface) on the substrate 3 that is held inside the cleaning material treatment chamber 31, and causes this cleaning material 1 to collide with this surface that is to be cleaned.

As seen from FIG. 1, the cleaning treatment chamber 31 has the bottom wall 33 which is an inclined surface that is inclined downward toward the discharge opening 34 which is formed in this wall 33 for waste liquid 1g. In addition, the cleaning treatment chamber 31 includes a supporting shaft 35 and a driving source (motor or the like) 36 which rotationally drives this supporting shaft 35. On the supporting shaft 35, the central portion of the back surface of the substrate 3 such as a semiconductor wafer or the like is carried so that the substrate is supported in a manner that allows free rotation of the substrate in the horizontal direction inside the chamber 31.

As shown in FIG. 1, the cleaning material spray mechanism 32 comprises a cleaning material sprayer 37 which is disposed inside the cleaning treatment chamber 31 in a state in which the nozzle opening faces the front surface that constitutes the surface which is the object of cleaning on the substrate (a member that is the object of cleaning) 3.

The cleaning material sprayer 37 is a spray gun, and it is constructed so that this spray gun accelerates and sprays the cleaning material 1 supplied from a cleaning material supply passage 7 connected to this spray gun by means of a carrier gas (nitrogen gas in the shown embodiment) 38 at a specified pressure. More specifically, a three-phase mixed fluid comprising a solid (ice particles 1d), a liquid (pure water or a mixed aqueous solution of pure water and IPA or the like 1e) and a gas (carrier gas 38) is sprayed from the spray gun 37 and caused to strike the front surface of the substrate 3 at a specified angle. In the shown embodiment, the spraying position of the cleaning material 1 is displaced from the central part of the substrate 3 toward the outer circumference by horizontal movement. Furthermore, the carrier gas 38 is supplied to the spray gun 37 from a gas supply source (gas tank) 40 via a gas supply passage 41.

A cooler 42 and a filter 43 are disposed in the gas supply passage 41, and the carrier gas 38 is supplied to the spray gun 37 after the gas has been cooled by the cooler 42 and contaminant particles have been removed by the filter 43. As shown in FIG. 1, the cooler 42 is a heat exchanger comprising a gas cooling tube 44 that is interposed in the gas supply passage 41, a heat exchanger main body 45 that contains this gas cooling tube 44, a cooling medium 28 that fills the heat exchanger main body 45, and a freezer 29 that cools the cooling medium 28; this cooler 42 cools the carrier gas 38 passing through the cooling tube 44 to a specified temperature by heat exchange with the cooling medium 28. The cooling medium 28 is circulated between the heat exchanger main body 45 of the cooler 42 and the heat exchanger main body 27 of the supercooler 13 by means of a cooling medium circulation passage 46 and a cooling medium circulation pump 47 disposed in this passage 46, and the cooling medium 28 of both coolers 13 and 42 is cooled by a shared freezer 29.

In the cleaning apparatus 4 constructed as described above (and in the cleaning material manufacturing apparatus 2), substrate cleaning is performed in an extremely favorable and effective manner by causing the sherbet-like cleaning material 1 in which a solid and liquid are co-present to be accelerated by the carrier gas 38, so that this cleaning material 1 is sprayed from the spray gun 37 and caused to strike the front surface of the substrate 3.

More specifically, unlike cases in which only a solid (ice particles) is accelerated by a carrier gas and caused to strike the substrate as in the ice scrubbers described above, a sherbet-like cleaning material 1 in which a solid (ice particles 1d) and liquid (water or a mixed aqueous solution of water and IPA or the like) are co-present is caused to collide with the substrate 3. Accordingly, the shock that is applied to the surface of the substrate 3 by the collision of the ice particles 1d is alleviated by the unfrozen liquid 1e. In other words, the liquid 1e which has a higher viscosity than the gas (carrier gas 38) functions as a liquid film shock absorbing material when the ice particles 1d collide with the substrate 3. Furthermore, the ice particles 1d contained in the cleaning material 1 are softer than the ice particles used in ice scrubbers, so that an extremely favorable cleaning capacity can be manifested even in the case of substrates 3 in which there is a danger of damage to the surface that is the object of cleaning when an ice scrubber is used.

As seen from the above, the surface of the substrate 3 is cleaned in a favorable fashion while securely preventing damage to the substrate 3 by the collision of the cleaning material 1. Furthermore, the ice particles 1d are not scattered following collision with the substrate 3, and the contaminant particles that are removed by the collision of the ice particles 1d are washed away by the liquid 1e in the cleaning material 1. Accordingly, a complete contamination-preventing effect is manifested without any danger of re-contamination of the substrate 3 by the removed contaminant particles. Furthermore, since the cleaning material 1 is a low-temperature (0° C. or lower) sherbet-like substance containing ice particles 1d, organic substances such as resist films or the like adhering to the substrate 3 are easily solidified, contracted and removed, thus further improving the cleaning effect. Moreover, since the sherbet-like cleaning material 1 is a low-temperature substance with a low vapor pressure, there is no danger of fire, and safe substrate cleaning is performed.

Furthermore, since the cleaning material 1 is a sherbet-like material and is maintained at the ice generating temperature even in cases where the contained ice 1d melts, the waste or excess heat of cooling can be recovered from the cleaning apparatus 4 and reutilized by recovering the waste liquid 1g, so that the running costs can be greatly reduced.

Moreover, in cases where the cleaning material is constructed solely from ice particles as in the ice scrubbers described above, there is a danger that the ice particles will melt and adhere to each other while being transported through the piping, thus forming large lumps that clog the piping or the like; and as a result, the transport piping of the cleaning material must be maintained at a high degree of cooling so that the ice particles do not melt. However, in the present invention, since the cleaning material 1 obtained by means of the cleaning material manufacturing apparatus 2 has a sherbet-like consistency in which a solid and liquid are co-present, there is no danger that the ice particles 1d will adhere to each other and form lumps even if the cooling means used in the transport piping system are simple. Accordingly, there is no blockage of the transport piping or the like, and the system has extremely superior handling characteristics.

A substrate 3 with no structural bodies was cleaned by spraying the sherbet-like cleaning material 1 at a high spray velocity close to the speed of sound, and the number and particle size of the contaminant particles on the surface of the substrate 3 were measured before and after cleaning, and the results are shown in Table 1. Furthermore, the number and particle size of the contaminant particles were measured by a wafer surface inspection device (LS-6000) manufactured by Hitachi, Ltd. The numbers of contaminant particles shown in Table 1 are the numbers of contaminant particles present on the surface of a silicon substrate with a diameter of 152 mm.

TABLE 1

| Particle size | Number of particles | Number of particles |
|---|---|---|
| of contaminant | before cleaning | after cleaning |
| particles (μm) | (particles) | (particles) |
| 0.17˜0.21 | 129 | 18 |
| 0.21˜0.50 | 250 | 6 |
| 0.50˜1.00 | 1569 | 5 |
| 1.00 or greater | 2067 | 2 |
| Total | 4015 | 31 |

As will easily be understood from Table 1, favorable cleaning was accomplished with no re-adhesion of contaminant particles ranging from particles with a particle size of 0.17 μm to particles with a particle size of 1.00 μm or greater; and it was thus confirmed that the cleaning of such substrates 3 is effectively performed by the present invention.

Damages to the substrate 3 following cleaning were also investigated. However, no damage of the type seen in cases where the ice scrubbers described above are used was observed, and it was thus confirmed that the cleaning of substrates and the like can be favorably performed according to the present invention. The reason for the advantages of the present invention is believed to be as describe below.

More specifically, in the substrate cleaning by means of ice scrubber of the prior art, the cleaning material consists of extremely low-temperature ice which has a high hardness and a strong solid inter-molecular force; consequently, although the cleaning capacity is high, there is considerable damage to the object of cleaning, such as residual cleaning scars on the substrate surface and the like. In the case of the cleaning material 1 of the present invention, on the other hand, the ice is at a relatively high temperature, and the inter-molecular force of the solid is weak, so that the hardness is low. Accordingly, the ice itself is easily pulverized.

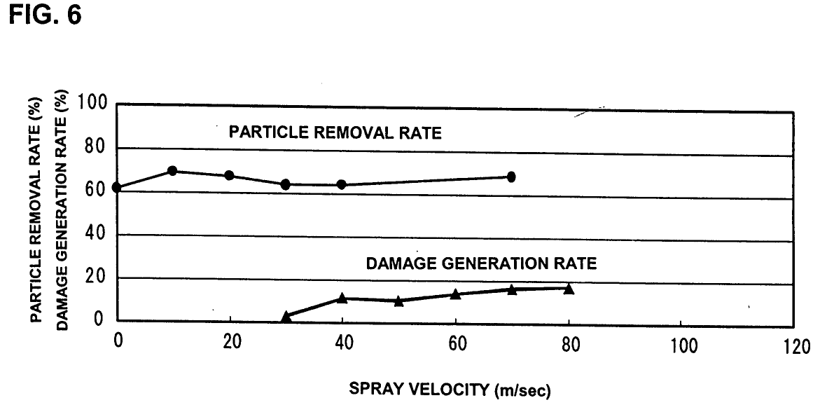

Furthermore, the correlations of damage occurrence rate and particle removal rate to spray velocity were determined in a case in which a silicon compound structural body with a thickness of several tens of nanometers formed as a film on the substrate 3 was cleaned using the cleaning material 1 of the present invention, and the results are shown in FIG. 6. It was ascertained that if the spray velocity is 30 m/sec or less, no damage is generated in the silicon compound structural body with a thickness of several tens of nanometers formed as a film on the substrate 3. In addition, when the correlation between particle removal rate (particle size: approximately 1 μm) and spray velocity was determined, it was ascertained that the particle removal rate is high even in a region where damage does not occur.

Accordingly, it is clear that if it is arranged so that the cleaning material 1 of the present invention is sprayed at a spray velocity of 30 m/sec or less, contaminant particles are cleaned away without damaging even a silicon compound structural body with a thickness of several tens of nanometers formed as a film on the substrate. More specifically, effective cleaning is accomplished over a wide range ranging from soft objects of cleaning that are extremely susceptible to damage to hard objects of cleaning from which extremely small contaminant particles are to be removed as described above.

Furthermore, the cleaning material 1 of the present invention has an excellent cleaning capacity. More specifically, ice scrubbers of the prior art involve a two-phase flow of solid and gas. When the solid strikes contaminant particles adhering to the substrate surface, these particles are moved. Afterward, however, the contaminant particles cannot be completely removed from the object of cleaning; and re-adhesion of the contaminant particles occurs. Accordingly, it has been necessary to cause the constant flow of an extremely large amount of rinse water (approximately 20 L/min) during cleaning in order to prevent the moved contaminant particles from re-adhering. Conventionally, therefore, the actual situation has been such that the cleaning capacity of ice cleaning materials cannot be effectively utilized. On the other hand, the cleaning material 1 of the present invention involves a three-phase flow of solid, gas and liquid. Accordingly, the contaminant particles that are moved by the solid can be washed away by the liquid without re-adhering to the substrate. Thus, contaminant particles are removed extremely efficiently by using the cleaning material 1 of the present invention.

In the case of ice scrubbers used in the prior art, the cleaning material itself is at an extremely low temperature; accordingly, problems such as the blockage of piping caused by fusion of the ice particles to each other due to the invasion of heat from the outside during transport through the piping have been encountered. In order to prevent such problems, it has been necessary to take measures in terms of the piping structure and heat insulation in order to maintain the temperature of the ice itself. On the other hand, in the cleaning material 1 of the present invention, the temperature of the ice itself is higher than that of the prior art, and furthermore, the cleaning material 1 itself possesses fluidity. Accordingly, ice transport is accomplished without taking any special measures in terms of heat insulating performance or piping structure, and this cleaning material 1 is superior in terms of handling characteristics.

The present invention is not limited to the configuration described above, and various improvements or alterations can be appropriately made within limits that involve no departure from the basic principle of the present invention.

For example, the structure of the cleaning material manufacturing vessel can be increased in size in accordance with the amount of cleaning material. If necessary, furthermore, rinsing equipment using pure water or the like can be installed in the cleaning treatment chamber 31, and re-contamination by contaminant particles can be more securely prevented by performing a rinse following the main cleaning by the cleaning material 1. Of course, since the substrate 3 is rinsed by the liquid content in the cleaning material 1, the removed contaminant particles tend not to re-adhere to the substrate 3; however, even if these removed contaminant particles should re-adhere, the adhesive force of the contaminant particles is weak, and thus these particles are easily removed by the rinse.

Furthermore, the cleaning material manufacturing vessel 5 can be formed with a cylindrical shape whose central axis extends in the horizontal direction.

Moreover, besides having a cylindrical shape with a constant internal diameter as shown in FIG. 2, the nozzle body 61 can be formed with a cylindrical shape whose internal diameter is not constant, e.g., a conical tubular shape which has a gradual reduction in diameter toward the squirt opening 62, or the like.

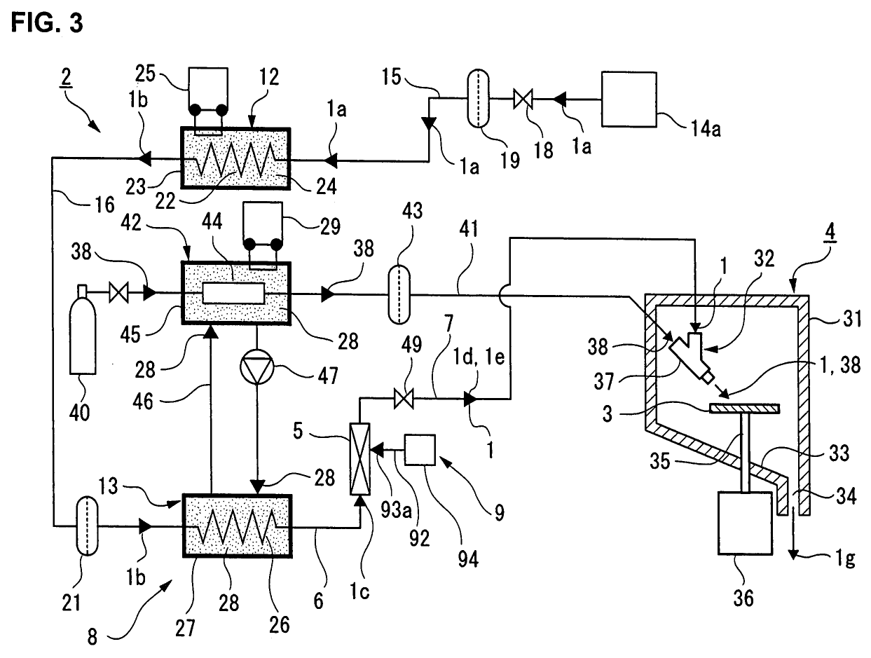

Furthermore, a pressurizing tank can be used instead of the pressurizing pump 20 as the pressurizing means for the supercooled liquid 1c. For example, it can be designed so that, as shown in FIG. 3, a pressurizing tank 14a is used as a supply source of the raw material liquid 1a, so that a pressurized raw material liquid 1a is supplied.

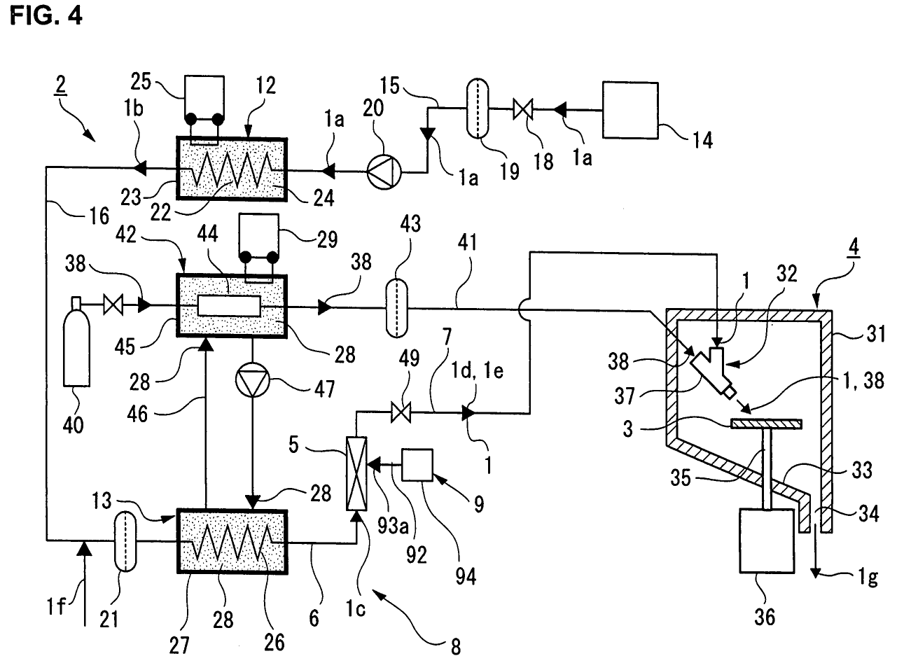

Furthermore, as shown in FIG. 4, it can be designed so that carbon dioxide gas 1f is introduced on the inlet side of the supercooler 13, thus obtaining a supercooled liquid 1c and cleaning material 1 that contain carbon dioxide gas 1f. With this structure, re-adhesion of contaminant particles to the substrate surface due to static electricity is effectively prevented in the cleaning of substrates 3 by the cleaning material 1.

Except for the above-described points, the construction of the cleaning system shown in FIG. 3 or FIG. 4 is the same as that of the cleaning system shown in FIGS. 1 and 2.

Besides the above-described spray gun, any universally known sprayer can be used as the cleaning material sprayer 37 in accordance with the properties of the cleaning material 1, cleaning conditions and the like.

Furthermore, besides being applied to the cleaning of substrates 3 such as the above-described semiconductor wafers or the like, the cleaning system of the present invention is appropriately applicable to other objects of cleaning that are generally subjected to spray cleaning by a liquid; and this can be accomplished by controlling the supercooling temperature of the supercooled liquid 1c (controlling the temperature or controlling the concentration of the mixed aqueous solution with IPA or the like) so that the ice concentration in the cleaning material 1 is adjusted, or by altering the spraying configuration of the cleaning material 1 by the cleaning apparatus 4 (i.e., by altering the spray velocity, spray angle, spray distance, cleaning nozzle structure or the like).

1. A cleaning material manufacturing method comprising the steps of:
obtaining a supercooled liquid which is formed by cooling a raw material liquid which is either water or a mixed liquid that comprises water and a liquid organic compound which has a lower freezing point than water;
creating a turbulent flow region of said supercooled liquid inside a cleaning material manufacturing vessel by causing said supercooled liquid to jet into said vessel from a supercooled liquid squirt opening formed in one end portion of said vessel;
obtaining a cleaning material, which has a sherbet-like consistency showing a co-presence of a solid and liquid in which ice particles and a liquid are mixed, by causing a portion of the supercooled liquid that is caused to jet from said supercooled liquid squirt opening to contact seed ice that is generated inside said vessel, so that a phase change into ice particles is effected, and by performing turbulent flow agitation in said turbulent flow region so as to grow said ice particles; and
causing the cleaning material thus obtained to flow out of said vessel into a cleaning material supply path that is connected to another end portion of said vessel.

2. The cleaning material manufacturing method according to claim 1,
wherein said cleaning material manufacturing vessel is formed with a cylindrical shape with one end portion of said vessel being closed off by an end portion wall, and a nozzle body whose tip end opening part is used as said supercooled liquid squirt opening is formed in said end portion wall so that said nozzle body protrudes into said cleaning material manufacturing vessel from said end portion wall; and
wherein said turbulent flow region is created inside said cleaning material manufacturing vessel, and a reverse flow is formed which is oriented toward said squirt opening from said end portion wall along the outer circumferential surface of the nozzle body.

3. The cleaning material manufacturing method according to claim 1, wherein a liquid into which carbon dioxide gas has been injected is used as the raw material liquid.

4. The cleaning material manufacturing method according to claim 1, wherein isopropyl alcohol is used as the liquid organic compound.

5. The cleaning material manufacturing method according to claim 1, wherein in cases where a mixed liquid composed of water and a liquid organic compound is used as the raw material liquid, a concentration of the liquid organic compound is set at 0.01 mass % to 70 mass %.

6. The cleaning material manufacturing method according to claim 1, wherein a jetting speed of the supercooled liquid from said supercooled liquid squirt opening is set at 1 m/sec to 20 m/sec.

7. The cleaning material manufacturing method according to claim 1, wherein the supercooled liquid that is caused to jet from said supercooled liquid squirt opening is maintained at a temperature of −0.5° C. to −50° C.

8. The cleaning material manufacturing method according to claim 1, wherein in an initial stage of manufacture of the cleaning material, the seed ice is fixed to an inner circumferential surface of said cleaning material manufacturing vessel and is caused to grow in a direction facing a liquid feeding direction.

9. The cleaning material manufacturing method according to claim 1, wherein the raw material liquid is pure water.

10. The cleaning material manufacturing method according to claim 1, wherein the seed ice raw material liquid that is a raw material of the seed ice is pure water.

11. The cleaning material manufacturing method according to claim 1, wherein a mixed liquid which has the same components as the raw material liquid is used as the seed ice raw material liquid, and a concentration of the liquid organic compound in the seed ice raw material liquid is set at a concentration that is the same as or lower than a concentration of the liquid organic compound in the raw material liquid.

12. A cleaning material manufacturing apparatus comprising:
a cylindrical cleaning material manufacturing vessel;
a supercooled liquid introduction passage which is connected to one end portion of said vessel and has a squirt opening formed in a tip end thereof;
a cleaning material supply passage which is connected to another end portion of said cleaning material manufacturing vessel;
a supercooled liquid manufacturing mechanism which cools a raw material liquid into a supercooled state and causes a thus obtained supercooled liquid to jet into said vessel from said squirt opening; and
a seed ice generating mechanism which generates seed ice in a turbulent flow region formed inside said vessel by the supercooled liquid that is caused to jet from said squirt opening;
wherein a portion of the supercooled liquid is caused to undergo a phase change into ice particles by contact with the seed ice, and the ice particles are caused to grow in said turbulent flow region, thus producing a cleaning material which has a sherbet-like consistency showing a co-presence of a solid and liquid in which ice particles and a liquid are mixed, and causing the cleaning material thus obtained to flow out of said vessel into the cleaning material supply passage.

13. The cleaning material manufacturing apparatus according to claim 12, wherein said raw material liquid is one selected from:
water,
a mixed liquid composed of water and a liquid organic compound having a freezing point lower than that of water,
water with carbon dioxide added thereto, and
a mixed liquid with carbon dioxide added thereto wherein the mixed liquid is composed of water and a liquid organic compound having a freezing point lower than that of water.

14. The cleaning material manufacturing apparatus according to claim 12, wherein said water is pure water.

15. The cleaning material manufacturing apparatus according to claim 12,
wherein said cleaning material manufacturing vessel is formed with a cylindrical shape with one end portion of said vessel being closed off by an end portion wall, and a nozzle body whose tip end opening part is used as said supercooled liquid squirt opening is formed in said end portion wall so that said nozzle body protrudes into said cleaning material manufacturing vessel from said end portion wall; and
wherein said turbulent flow region is created inside said cleaning material manufacturing vessel, and a reverse flow is formed which is oriented toward said squirt opening from said end portion wall along the outer circumferential surface of the nozzle body.

16. The cleaning material manufacturing apparatus according to claim 15, wherein at least a contact surface of said nozzle body and end portion wall with the supercooled liquid is formed with a low-temperature-resistant material that is superior in terms of hydrophobic properties and low thermal conductivity.

17. The cleaning material manufacturing apparatus according to claim 15, wherein central axes of said cleaning material manufacturing vessel and nozzle body are caused to coincide.

18. The cleaning material manufacturing apparatus according to claim 12, wherein said cleaning material manufacturing vessel is constructed as a vessel with a cylindrical shape whose central axis extends in a vertical direction or horizontal direction, a supercooled liquid introduction passage is connected to one end portion of said vessel, and said cleaning material supply passage is connected to another end portion of said vessel.

19. The cleaning material manufacturing apparatus according to claim 12, wherein said seed ice generating mechanism comprises:
a seed ice generating opening that is formed in circumferential walls of said cleaning material manufacturing vessel or in a direction facing a liquid feeding direction,
a seed ice generating passage that is connected to said seed ice generating opening, and
a cooler which generates seed ice by cooling the seed ice raw material liquid that is resident in said seed ice generating passage.

20. A cleaning system comprising a cleaning apparatus and the cleaning material manufacturing apparatus according to claim 12, 13, 14, 15, 16, 17, 18 or 19; wherein said cleaning apparatus comprises:
a cleaning treatment chamber which holds a member that is an object of cleaning, and
a cleaning material spray mechanism which spays a cleaning material that is supplied from the cleaning material supply passage onto the member that is the object of cleaning held inside the cleaning treatment chamber.

21. The cleaning system according to claim 20, wherein in said cleaning material supply passage that extends from said cleaning material manufacturing apparatus to said cleaning material spray mechanism, the cleaning material that flows through said passage is maintained at a temperature of −0.5° C. to −50° C.

22. The cleaning system according to claim 20, wherein said cleaning material spray mechanism is provided with a spray gun that uses a carrier gas to accelerate and spray the cleaning material that is supplied from said cleaning material supply passage.
